(19) United States
(12) Patent Application Publication
(10) Pub. No.: US 2026/0281354 A1
(43) Pub. Date: Sep. 17, 2026

(54) ADAPTIVE QUANTIZATION IN VIDEO CODING

(71) Applicant: MEDIATEK INC., Hsinchu City (TW)

(72) Inventors: Yi-Wen CHEN, San Jose, CA (US); Tzu-Der CHUANG, Hsinchu City (TW); Ching-Yeh CHEN, Hsinchu City (TW); Chih-Wei HSU, Hsinchu City (TW); Yu-Wen HUANG, Hsinchu City (TW)

(21) Appl. No.: 19/471,798

(22) PCT Filed: Jun. 27, 2024
(86) PCT No.: PCT/CN2024/102027

§ 371 Date: Oct. 2, 2025

Related U.S. Application Data
(60) Provisional application No. 63/510,376, filed on Jun. 27, 2023.
(60) Provisional application No. 63/524,726, filed on Jul. 3, 2023.

(51) Int. Cl. H04N 19/124; H04N 19/12; H04N 19/176; H04N 19/18; H04N 19/60

(52) U.S. Cl. CPC H04N 19/124; H04N 19/12; H04N 19/176; H04N 19/18; H04N 19/60

(57) ABSTRACT

A video coding method using adaptive quantization is provided. A video coder receives quantization indices for a transform block. The video coder applies a dequantization function on the quantization index to obtain a first dequantized value. The video coder shifts the quantization index by an amount determined according to coding information of the current block to generate a shifted quantization index. The video coder applies the dequantization function on the shifted quantization index to obtain a second dequantized value. The video coder computes a reconstructed transform coefficient of the transform block based on a weighted sum of the first dequantized value and the second dequantized value. The video coder reconstructs a current block of pixels of a current picture based on the reconstructed transform coefficients of the transform block.

### CROSS REFERENCE TO RELATED PATENT APPLICATION(S)

The present disclosure is part of a non-provisional application that claims the priority benefit of U.S. Provisional Patent Applications No. 63/510,376 filed on 27 Jun. 2023, and No. 63/524,726 filed on 3 Jul. 2023. Contents of above-listed applications are herein incorporated by reference.

### TECHNICAL FIELD

The present disclosure relates generally to video coding. In particular, the present disclosure relates to quantization of coded video data.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

A video coding method using adaptive quantization is provided. A video coder receives quantization indices for a transform block. The video coder applies a dequantization function on the quantization index to obtain a first dequantized value. The video coder shifts the quantization index by an amount determined according to coding information of the current block to generate a shifted quantization index. The video coder applies the dequantization function on the shifted quantization index to obtain a second dequantized value. The video coder computes a reconstructed transform coefficient of the transform block based on a weighted sum of the first dequantized value and the second dequantized value by applying an offset having a same sign as the quantization index. The video coder reconstructs a current block of pixels of a current picture based on the reconstructed transform coefficients of the transform block.

In some embodiments, the video coder shifts the quantization index away from zero by adding or subtracting N to the quantization index, N being a positive integer. In some embodiments, N is 1. In some embodiments, N greater than 1. In some embodiments, N is determined based on coding information of the current block, such that, for example, N is a first value when a first coding tool is used to encode the current block and a second, different value when a second coding tool is used to encode the current block. The coding information may be anyone of the size/shape of the block, the coding tool used code the block, etc.

In some embodiments, N is a value indicated at a particular hierarchical level of a coded video bitstream, such as sequence level, (e.g. video parameter set and sequence parameter set), picture level (e.g. picture parameter set and picture header), slice level (e.g. slice header) and/or block level (e.g. CTU, CU, PU, TU, CTB, CB, PB, TB). In some embodiments, N is predefined at corresponding video codecs. In some embodiments, N is determined based on the value of the quantization index, for example, N may take different values based on whether the quantization index is greater or less than a threshold.

The video coder may apply the dequantization function by scaling the quantization index by a quantization stepsize (Qₛₜₑₚ). In some embodiments, the quantization stepsize may be determined based on the coding information of the current block. The video coder may compute the weighted sum by weighting the first dequantized value by a first weighting value (w0) and weighting the second dequantized value by a second weighting value (w1), and by bitwise shifting the weighted sum by B bits.

In some embodiments, the video coder may determine B, w0, and w1 based on the coding information of the current block. In some embodiments, the values of B, w0 and w1 are indicated by syntax elements at a particular hierarchical level of a coded video bitstream, such as sequence level, (e.g. video parameter set and sequence parameter set), picture level (e.g. picture parameter set and picture header), slice level (e.g. slice header) and/or block level (e.g. CTU, CU, PU, TU, CTB, CB, PB, TB). In some embodiments, B, w0, and w1 are predefined at video codecs. In some embodiments, B, w0, and w1 are determined based on the value of the quantization index.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 conceptually illustrates corresponding quantization and dequantization processes in video coding systems.

FIGS. 2A-C illustrate a section of the Versatile Video Coding (VVC) specification that specifies the dequantization/scaling process for transform coefficients.

FIG. 3 illustrates two scalar quantizers used in dependent quantization.

FIG. 4 illustrates state transition and quantizer selection for the dependent quantization.

FIG. 5 illustrates regions of interest for Low Frequency Non-Separable Transform (LFNST).

FIG. 6 shows the mapping from intra prediction modes to LFNST sets.

FIG. 7 illustrates an example video encoder that may implement adaptive quantization.

FIG. 8 illustrates portions of the video encoder that implement adaptive quantization.

FIG. 9 conceptually illustrates a process that uses adaptive quantization in encoding pixel blocks.

FIG. 10 illustrates an example video decoder that may perform adaptive quantization.

FIG. 11 illustrates portions of the video decoder that implement adaptive quantization.

FIG. 12 conceptually illustrates a process that uses adaptive quantization in decoding pixel blocks.

FIG. 13 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Transforms

HEVC, like its predecessors, employs transform coding of the prediction error residual. The residual block is divided into several square transform blocks (TBs), which can be of varying sizes ranging from 4×4 to 32×32. To calculate two-dimensional transforms, 1-D transforms are performed separately in both the horizontal and vertical directions. The core transform matrices are designed by approximating scaled DCT (discrete cosine transform) basis functions while taking into account factors such as reducing the required dynamic range for transform computation and optimizing the accuracy and orthogonality of the matrix entries when represented as integer values.

VVC not only utilizes separable square transforms with kernel sizes ranging from 4×4 to 32×32, VVC also support non-square transforms by combining various kernel sizes that increase dyadically from length-2 to length-64 both horizontally and vertically.

The fundamental idea of utilizing an integer transform to the prediction residual and then quantizing the resulting coefficients is still utilized in VVC. However, VVC also implements extended transforms, refined quantization, and residual coding to achieve superior energy compaction of the prediction residual. VVC utilizes more advanced designs on transforms and quantization to achieve better coding performance.

Alternative transforms may be more effective at decorrelating the prediction residual, particularly in the case of the intra prediction residual where the prediction error tends to increase as the distance from the boundary samples increases. In HEVC, this is addressed by incorporating an additional 4×4 integer approximation of the DST type-VII for intra prediction luma residuals. VVC takes this a step further by introducing four additional horizontal/vertical combinations of separate DST type-VII and DCT type-VIII integer kernels for all square and non-square luma block sizes ranging from 4×4 to 32×32. This is known as multiple transform set (MTS). The selection of which transform to use is either explicitly signaled per CU or implicitly derived based on the width and height of the transform block. Similar to the DCT type-II based transform of length 64, the non-DCT type-II coefficients outside a 16×16 area are zeroed out to reduce the implementation complexity of the additional transforms.

The encoder has the ability to apply a set of non-separable mode-dependent transforms to the low frequency coefficients of the DCT type-II based primary transform in intra-coded blocks. This is known as Low Frequency Non-Separable Transform (LFNST). These additional inverse transform kernels were derived from training data to take advantage of the remaining directionality characteristics present in the intra-picture prediction residual signals.

When coding inter-predicted CUs, a sub-partition of the residual block is selected to be coded while the remaining portion is skipped. This is known as Subblock Transform (SBT) Mode. The coded residual sub-partition can be either half or one-quarter the size of the CU, with an MTS transform type for the coded residual being implicitly inferred. The left, right, top, or bottom part of the coded half or quarter sub-partition can be selected, resulting in a total of 8 modes that need to be signaled per CU.

### II. Scaling and Quantization

HEVC employs a quantization scheme known as Uniform Reconstruction Quantization (URQ), which is similar to the one used in H.264/MPEG-4 AVC, and is governed by a quantization parameter (QP). The QP values range from 0 to 51, and each increment of 6 results in a doubling of the quantization step size, thus providing a roughly logarithmic mapping of QP values to step sizes. Additionally, HEVC supports quantization scaling matrices. An increment of 1 in the quantization parameter results in a step size increase of roughly 12% (i.e., 2^{1/6}). Meanwhile, an increase of 6 results in a doubling of the step size. The resulting relationship between and the equivalent quantization step size for an orthonormal transform is now given by Qₛₜₑₚ(QP)=(2^{1/6})Q^{P-4}, which could also be expressed as Qₛₜₑₚ(QP)=G_{QP %6}<<(QP/6), where G=[G₀,G₁, . . . G₅]=[2^{-4/6}, 2^{-3/6}, 2^{-2/6}, 2^{-1/6}, 2⁰, 2¹]. Qₛₜₑₚ is then used to perform quantization in the encoding process, by scaling the transform coefficient C to get the quantized transform coefficient level L:

$$L = C / {Q}_{step} \qquad Eq . ( 1 )$$

At the decoder, the quantization step size Qₛₜₑₚ is used to perform dequantization in the decoding process, by scaling the quantized coefficient level L to get the transform coefficient C:

$$C = L * {Q}_{step} \qquad Eq . ( 2 )$$

Eq. (1) can also be written as y=Q(x), where x are the transform coefficients, Q(·) is the quantization function (that applies the stepsize Qₛₜₑₚ), and y is the quantized transform coefficient levels (also known as quantization indices, yᵢ represent an individual quantization index.) Correspondingly, Eq. (2) can be written as x=Q⁻¹(y), where Q⁻¹(·) is the corresponding dequantization function for Q(·). For systems with finite precisions, the dequantization function Q⁻¹(y) can only be used to obtain reconstructed transform coefficients \hat{x}.

In some embodiments, quantization and dequantization can be performed by scaling (e.g., bitwise shifting) and rounding (with a rounding offset.) In other words, the formula for quantization (y=Q(x)) can be written as:

$${y}_{i} = round ( ( T + {offset}_{round} ) / stepsize ) \qquad Eq . ( 3 )$$

where yᵢ is a quantization index calculated during the encoding process, T is the transform coefficient value (or C in Eq. (1), offset_{round} is a value for adjusting the rounding of the coefficients, stepsize is the quantization step size (or Qₛₜₑₚ in Eq. (1). The corresponding formula for dequantization (also termed scaling process) is:

$${Q}^{- 1} ( {y}_{i} ) = round ( {y}_{i} \times stepsize + {offset}_{round} ) \qquad Eq . ( 4 )$$

where Q⁻¹(yᵢ) is the dequantized transform coefficient (or reconstructed coefficient). Since yᵢ and stepsize have finite precision, the dequantized transform coefficient Q⁻¹(yᵢ) (or reconstructed transform coefficient \hat{x}) is not expected to be exactly the same as the original transform coefficient value T.

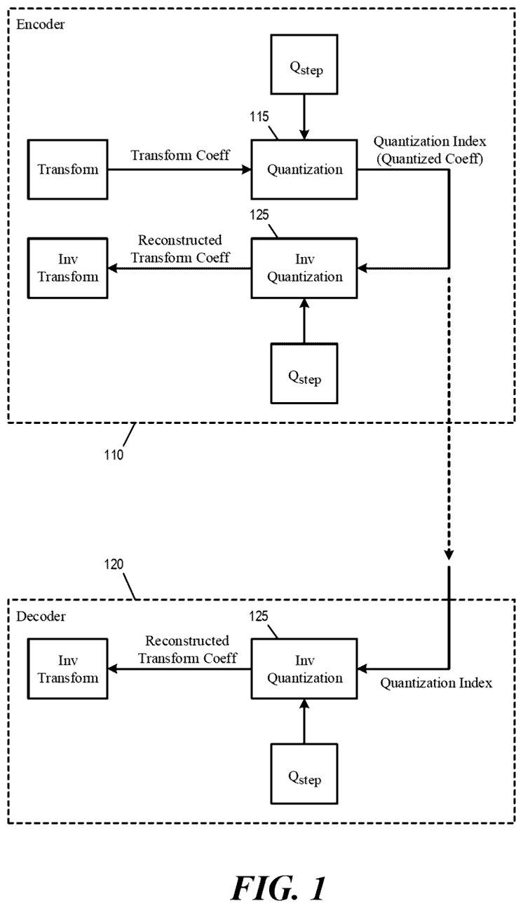

For some embodiments, FIG. 1 conceptually illustrates corresponding quantization and dequantization processes in video coding systems. As illustrated, a video encoder 110 generates transform coefficients (based on e.g., prediction residuals in pixel domain). The transform coefficients (T or C or x) are quantized by a quantization function 115 to produce quantized coefficients or quantization indices (L or y). A video decoder 120 receives the quantization indices. A dequantization function 125 performs dequantization to generate reconstructed transform coefficients (Q⁻¹(y) or \hat{x}.) The video encoder 110 also receives the quantization indices and performs the same dequantization function 125 to generate the same reconstructed transform coefficients.

In some embodiments, the dequantization function 115 (in the encoder and the decoder) performs dequantization by scaling the quantization indices based on a stepsize (or Qₛₜₑₚ) (with rounding and rounding offsets). In some embodiments, the dequantization function 125 uses shifted quantization indices and adaptive quantization as described by Sections III and IV below.

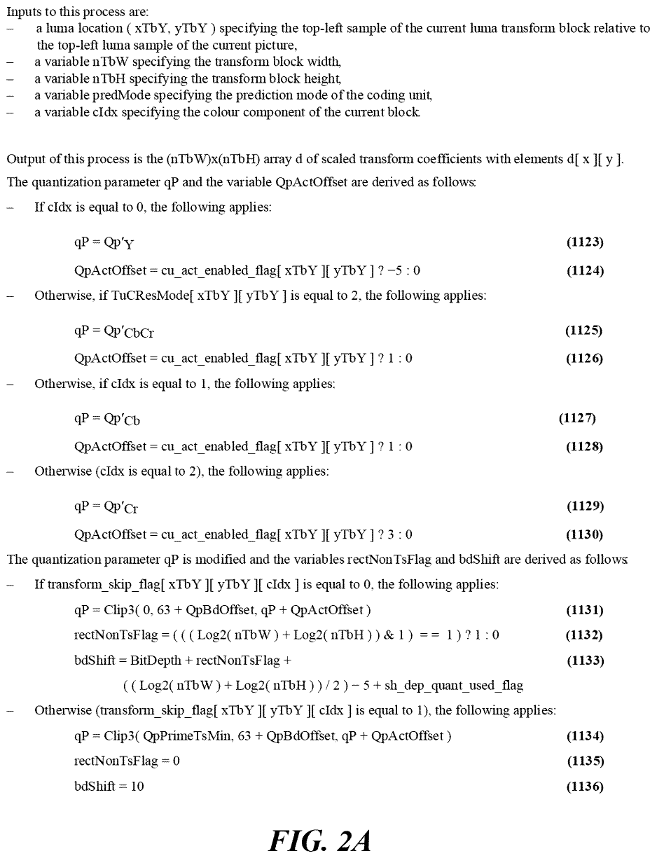

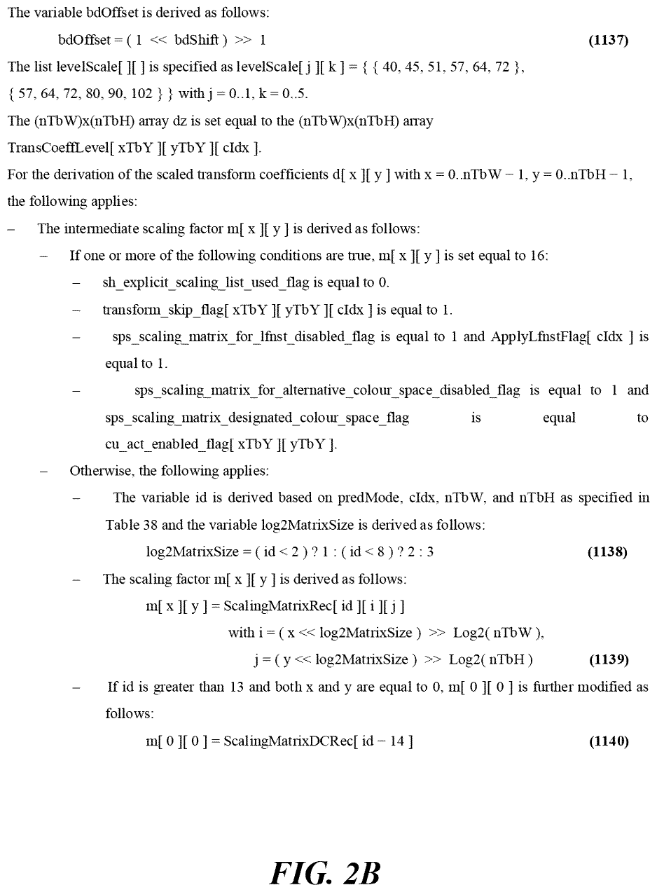

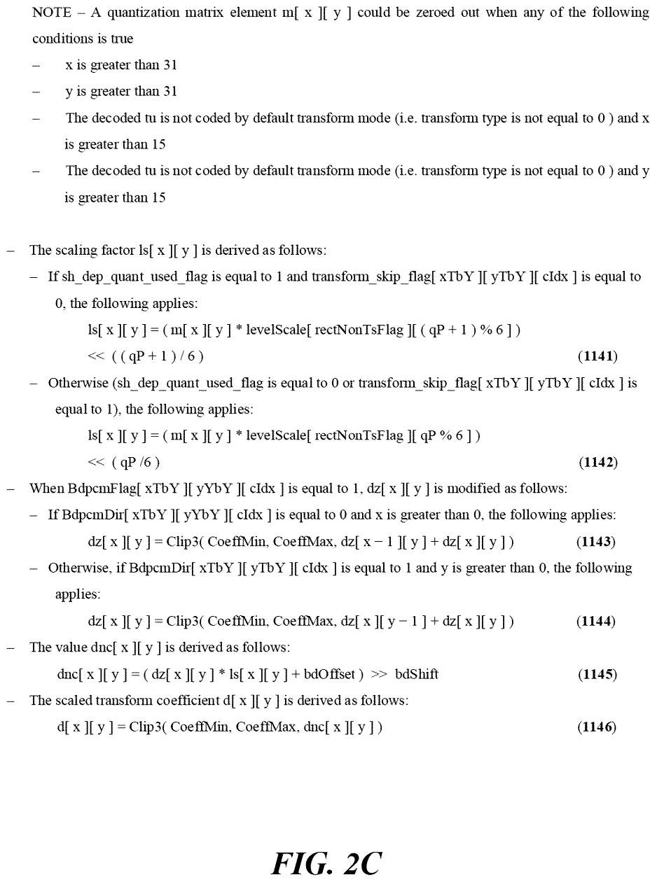

FIGS. 2A-C illustrate a section of the Versatile Video Coding (VVC) specification that specifies the dequantization/scaling process for transform coefficients. The illustrated section of VVC shows a dequantization process that includes equations (1123) through (1146). For example, according to the equation (1145)

$$dnc [ x ] [ y ] = ( dz [ x ] [ y ] * ls [ x ] [ y ] + bdOffset ) >> bdshift$$

Q⁻¹(yᵢ) corresponds to the dnc[x][y], yᵢ corresponds to the dz[x][y], and Qₛₜₑₚ is expressed as ls[x][y]>>bdShift. The bdOffset is a value for adjusting the rounding effect. The quantization stepsize ls[x][y](or scaling factor or invQScale) is calculated based on the values of the quantization parameter (qP) and the quantization matrix m[x][y].

In order to achieve lower bit rates, VVC supports extended quantization control by supporting a larger maximum QP value than HEVC. While the maximum QP value in HEVC is 51, VVC can support QP values up to 63, resulting in a maximum inverse quantization scaling step size that is four times larger. The QP can be adjusted locally for rate control and perceptual optimization. To facilitate this, VVC retains the concept of quantization groups for signaling a luma QP offset and scaling lists for frequency-dependent inverse quantization scaling from HEVC, which has been adapted to support non-square block structures. The only difference from HEVC is a constant offset of 6*(b-8) which depends on the bit depth b of the decoded video samples.

In VVC, the encoder enables the switching between two scalar inverse quantizers for decoding each transform coefficient based on the value of the previous quantized coefficient. This technique, known as Dependent Quantization (DQ), despite using a scalar inverse quantizer at the decoder, can be considered a type of vector quantization as it jointly encodes the transform coefficients in an interdependent manner, utilizing a trellis-based search at the encoder. Additionally, VVC retains the sign data hiding (SDH) approach introduced in HEVC as a lower-complexity alternative to DQ, which is another dependent coding trick.

Dependent scalar quantization (DSQ) refers to an approach in which the set of admissible reconstruction values for a transform coefficient depends on the values of the transform coefficient levels that precede the current transform coefficient level in reconstruction order. The main effect of this approach is that, in comparison to conventional independent scalar quantization as used in HEVC, the admissible reconstruction vectors are packed denser in the N-dimensional vector space (N represents the number of transform coefficients in a transform block). That means, for a given average number of admissible reconstruction vectors per N-dimensional unit volume, the average distortion between an input vector and the closest reconstruction vector is reduced. The approach of dependent scalar quantization is realized by: (a) defining two scalar quantizers with different reconstruction levels and (b) defining a process for switching between the two scalar quantizers.

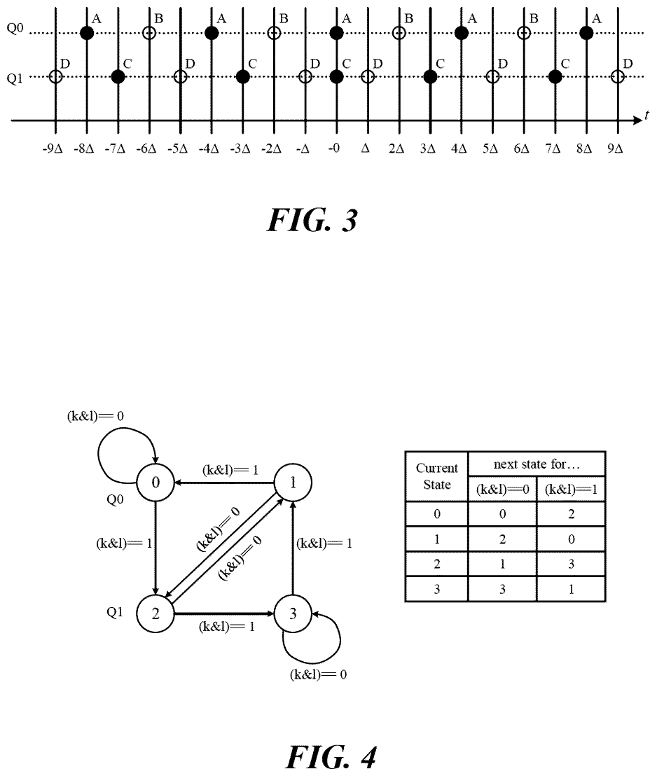

FIG. 3 illustrates two scalar quantizers used in dependent quantization. The figure illustrates two scalar quantizers that are denoted as Q0 and Q1. The location of the available reconstruction levels is uniquely specified by a quantization step size A. The scalar quantizer used (Q0 or Q1) is not explicitly signalled in the bitstream. Instead, the quantizer used for a current transform coefficient is determined by the parities of the transform coefficient levels that precede the current transform coefficient in coding/reconstruction order.

FIG. 4 illustrates state transition and quantizer selection for the dependent quantization. As illustrated, the switching between the two scalar quantizers (Q0 and Q1) is realized via a state machine with four states. The state can take four different values: 0, 1, 2, 3. It is uniquely determined by the parities of the transform coefficient levels preceding the current transform coefficient in coding/reconstruction order. At the start of the inverse quantization for a transform block, the state is set equal to 0. The transform coefficients are reconstructed in scanning order (i.e., in the same order they are entropy decoded). After a current transform coefficient is reconstructed, the state is updated as shown in FIG. 4, where k denotes the value of the transform coefficient level.

In some embodiments, the LFNST is extended according to the following: the number of LFNST sets (S) and candidates (C) are extended to S=35 and C=3, and the LFNST set (lfnstTrSetIdx) for a given intra mode (predModeIntra) is derived according to the following formula:
For predModeIntra <2, lfnstTrSetIdx is equal to 2
lfnstTrSetIdx=predModeIntra, for predModeIntra in [0,34]
lfnstTrSetIdx=68−predModeIntra, for predModeIntra in [35,66]

Three different kernels, LFNST4, LFNST8, and LFNST16, are defined to indicate LFNST kernel sets, which are applied to 4×N/Nx4 (N≥4), 8×N/Nx8 (N≥8), and MxN (M, N≥16), respectively. In some embodiments, the kernel dimensions are specified by:

(LFSNT4, LFNST8*, LFNST16*)=(16×16, 32×64, 32×96)

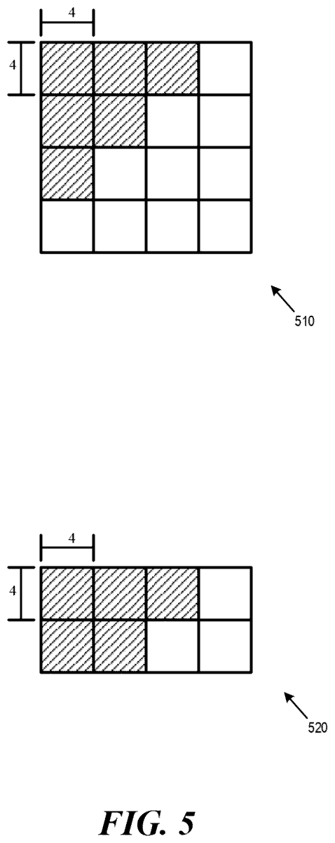

The forward LFNST is applied to top-left low frequency region, which is called Region-Of-Interest (ROI). When LFNST is applied, primary-transformed coefficients that exist in the region other than ROI are zeroed out. FIG. 5 illustrates regions of interest for LFNST, specifically for LFNST16 and LFNST8. The figure illustrates a ROI 510 for LFNST16, which consists of six 4×4 sub-blocks that are consecutive in scan order. Since the number of input samples is 96, transform matrix for forward LFNST16 can be Rx96. R is chosen to be 32 in this contribution, 32 coefficients (two 4×4 sub-blocks) are generated from forward LFNST16 accordingly, which are placed following coefficient scan order. The figure also illustrates a ROI 520 for LFNST8. The forward LFNST8 matrix can be Rx64 and R is chosen to be 32. The generated coefficients are located in the same manner as with LFNST16.

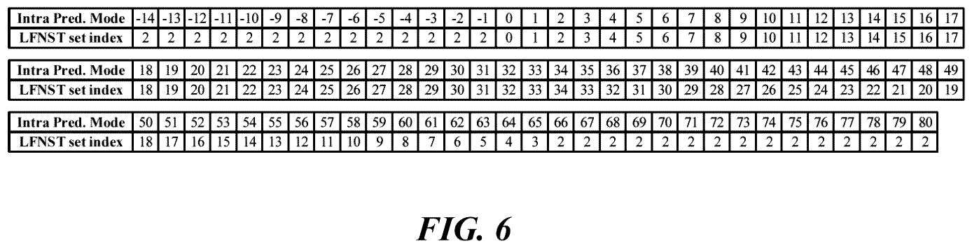

In some embodiments, intra prediction mode that is used to encode a block can be used to determine which set of LFNST is used. FIG. 6 shows the mapping from intra prediction modes to LFNST sets.

In some embodiments, quantization is performed using integer arithmetic, with quantizer step size doubling for every increase of QP by 6. The QP remainder (QP %⁶) specifies a fractional scaling of the quantizer step size normalized at 16384 (corresponding to 2^{QUANT_SHIFT}, with QUANT_SHIFT equal to 14) and using a table f[x]. When scaling lists are used, an additional fractional scaling is performed that depends on the position of the transform coefficient in the TB, with either a default scaling list used, or a scaling list supplied via a file. The additional fractional scaling is normalized at 16. Scaling lists can be derived for different sized TBs and prediction modes. When scaling lists are not used, the quantized transform coefficients qᵢⱼ (i, j=0..nS-1) are derived from the transform coefficients dᵢⱼ (i, j=0..nS-1) and the scaling list sᵢⱼ (i, j=0..nS-1) as

qᵢⱼ=(dᵢⱼ*f[QP%6]+offset)>>(QUANT_SHIFT+MAX_TR_DYNAMIC_RANGE+QP/6−log₂(nS)−BitDepth), with i,j=0, . . . ,nS-1, where,

f[x]={26214,23302,20560,18396,16384,14564}, x=0, . . . ,5

2^{28+QP/6-nS-BitDepth}<offset<₂29+QP/6-nS-BitDepth QUANT_SHIFT=14

MAX_TR_DYNAMIC_RANGE=15

when extended precision processing flag is equal to 0.

When scaling lists are used, the quantized transform coefficients qᵢⱼ (i, j=0..nS-1) are derived from the transform coefficients dᵢⱼ (i, j=0..nS-1) and the scaling list sᵢⱼ (i, j=0..nS-1) as

qᵢⱼ=(dᵢⱼ*(f[QP%6]<<4/sᵢⱼ)+offset)>>(QUANT_SHIFT +MAX_TR_DYNAMIC_RANGE+QP/6−log₂(nS)−BitDepth),
with i,j=0, . . . ,nS-1

The value offset is set at 171/512 for I slices and 85/512 for P or B slices. When scaling lists are not applied, sᵢⱼ=16 for all i and j.

### III. Shifting Quantization Center

It is shown that end-to-end compression models are an unconstrained multi-objective optimization problem where the solution should meet Karush-Kuhn-Tucker (KKT) conditions. According to KKT conditions, the sum of gradient with respect to each objective should be zero. Since there are two objectives (rate and distortion), the gradient with respect to distortion and the gradient with respect to rate should cancel themselves out (they show opposite directions). Thus, one can be used instead of the other by simply changing direction. It was shown that shifting the latents (the transform coefficient) by the gradient with respect to rate (available on decoder side) as it is negative of gradient with respect to distortion (unavailable in decoder side) can allow 1-2% bd-rate gain on end-to-end compression models. In the scheme of shifting quantization center, the transform coefficient is shifted by using the gradient of very simple rate prediction in order to decrease the quantization error.

In some embodiments, some offset value is added, which is driven by gradient of the entropy on the reconstructed transform coefficients. The RDO based quantization such as Dependent Quantization (DQ) with Trellis Coded Quantization procedure (TCQ) is assumed to be an unconstrained multi-objective optimization problem that can be generalized by:

$${y}^{*} = {argmin}_{y} [ R ( y ) + λ D ( x , {Q}^{- 1} ( y ) ) ] \qquad Eq . ( 5 )$$

In this equation, x ∈ Rⁿ is the n length real numbered coefficient to be quantized, y ∈ Zⁿ is the quantization indices (or quantized level indices) defined on discrete set of reconstruction points. Using any quantizer Q(·) and dequantizer function Q⁻¹(·), the indices and reconstruction can be obtained by y=Q(x) and \hat{x}=Q⁻¹(y) respectively. Here, function R(·) is the rate function of the indices and function D(·, ·) is a distortion metric such as Mean Square Error (MSE). Using KKT conditions on Eq.(5), it can be shown that if the solution found by RDO based quantization is optimal, the following condition should be met.

$${∇}_{y} ( R ( y ) ) = - λ {∇}_{y} ( D ( x , {Q}^{- 1} ( y ) ) ) \qquad Eq . ( 6 )$$

Of the first order gradient-based optimization methods, if the current solution takes a step to the negative direction of its gradient with regard to some objective function, this objective function gets smaller. For RDO based quantization case, if the quantization indices (or quantized level indices) y are shifted by gradient with regard to distortion such as y←y−ρV̅_{y} (D(x, Q⁻¹(y))), where ρ ∈ R⁺ is step size, the distortion D(x, Q⁻¹(y)) gets smaller. However, it is not possible to know distortion without knowing original input data explicitly. But using Eq. (6), the negative gradient with respect to rate is used as it is its gradient with respect to distortion. Thus, the quantization indices maybe shifted in the loop of encoder's quantization and decoder's dequantization by Eq. (7) as follows:

$$y ← y + ρ {∇}_{y} ( R ( y ) ) \qquad Eq . ( 7 )$$

Eq. (7) indicates that some offset value can be added to the quantization indices (y) (or dequantized coefficients Q⁻¹(y)) to increase the rate. But since this added offset can be applied during the dequantization process, it has no effect on the rate but increases reconstruction quality.

In some embodiments, it is assumed very simple proxy of rate prediction where individual quantization indices (or quantized level indices) are independent, and rate increases by absolute value of the coefficient as shown in Eq. (8):

$$R ( {y}_{i} ) ≅ a \vert {y}_{i} \vert + b \qquad Eq . ( 8 )$$

Where yᵢ is an individual quantization index (or quantized level index) among the quantization indices y. Since the gradient of rate in Eq. (8) is 0 where yᵢ=0, +a where yᵢ>0 and −a where yᵢ<0, the offset can be applied as in Eq. (9).

$$\{ \begin{matrix}{y}_{i} ← {y}_{i} + {ρ}^{*} & {y}_{i} > 0 \\ {y}_{i} ← {y}_{i} - {ρ}^{*} & {y}_{i} < 0 \\ {y}_{i} ← {y}_{i} & {y}_{i} = 0\end{matrix} , \qquad Eq . ( 9 )$$

$$for i = 1 ¨ n$$

In some embodiments, the scheme of Eq. (9) can be seen as it applies some offset to the individual quantization indices yᵢ that makes them far away from zero point. The amount of the offset ρ*∈ R⁺ can be fine-tuned over a validation set and used as a universal value for all videos.

### IV. Adaptive Quantization

In some embodiments, a shifted quantization index is computed for dequantization according to the following:

$${y}_{i}^{′} = {y}_{i} + ( {y}_{i} > 0 ? 1 : - 1 ) \qquad Eq . ( 10 )$$

where y′ᵢ is a shifted quantization index (in this case it's quantization index yᵢ shifted by 1.) Specifically, according to Eq. (10), the shifted quantization index y′ᵢ is computed by having the quantization index yᵢ shifted by 1 in the opposite direction to the zero center. A reconstructed coefficient based on the shifted quantization index is denoted as Q⁻¹(y′ᵢ). For some embodiments, this shifting on quantization index or quantized level is done only if the quantization index is not zero.

In some embodiments, a video decoder performs dequantization by (i) compute Q⁻¹(yᵢ) (e.g., Eq. (4)); (ii) compute Q⁻¹(y′ᵢ) (e.g., Eq. (10)); and (iii) taking the weighted sum of Q⁻¹(yᵢ)) and Q⁻¹(y′ᵢ)) as the reconstructed coefficient in Eq. (11):

$$\hat{x} = ( 982 * {Q}^{- 1} ( {y}_{i} ) + 42 * {Q}^{- 1} ( {y}_{i}^{′} ) ) ≫ 10 \qquad Eq . ( 11 )$$

In some embodiments, the shifted quantization index y′ᵢ of Eq. (10) is extended by Eq. (12)

$${y}_{i}^{′} = {y}_{i} + ( {y}_{i} > 0 ? N : - N ) \qquad Eq . ( 12 )$$

where N could be any integer and is not limited to 1.

Different N values (as shown in Eq. (12)) could be utilized for a block, where a block here could be a coding unit (CU), coding block (CB), prediction unit (PU), prediction block (PB), transform unit (TU), transform block (TB), coding tree unit (CTU) or a coding tree block (CTB), according to the coding information associated with the block. The coding information includes but not limited to the coding modes of the block, the size of the block, the shape of the block, the height and/or width of the block, the slice type associated with the block, the quantization parameter (QP) associated with the block and so on. The coding modes include but not limited to: intra mode, inter mode (and/or inter prediction direction), Intra block copy mode (IBC), Inter affine mode, Inter Merge mode, Inter non-merge mode, MTS applied block, LFNST applied block, SBT applied block, among others.

In some embodiments, different N values may be utilized for different coefficient in a block. The coefficient in different scan position or scan index or diagonal position may have different N. The coefficient with different coded/decoded levels or yᵢ can have different N. For example, N1 is used as the N for the TB associated with an intra mode coded block while N2 is used as the N for the TB associated with a non-intra mode coded block. N1 and N2 could be any non-negative integer (e.g., N1=2 and N2=1.) It is noted that N may be assigned as equal to 0, which is equivalent to disabling the quantization center shift. The one or multiple N values (illustrated in Eq. (12)) may be predefined at both the encoder and decoder. Alternatively, the one or multiple N values may be signaled into the bitstream at different levels such as sequence level (e.g. video parameter set and sequence parameter set), picture level (e.g. picture parameter set and picture header), slice level (e.g. slice header) and/or block level (e.g. CTU, CU, PU, TU, CTB, CB, PB, TB).

In some embodiments, different N values may be utilized depending on different yᵢ values. In one example, different N values could be used for different sets of yᵢ. Specifically, N1 is used for yᵢ≤M while N2 is used for the other yᵢ values.

In some embodiments, the reconstructed coefficient in Eq. (11) is also extended to Eq. (13) below:

$$\hat{x} = ( w 0 * {Q}^{- 1} ( {y}_{i} ) + w 1 * {Q}^{- 1} ( {y}_{i}^{′} ) ) ≫ b \qquad Eq . ( 13 )$$

where b is any non-negative integer (e.g., 10) and w0 is also a non-negative integer while w1 is also a non-negative integer and w1 could be constrained to be (1<<b)−w0 (e.g., b=10, w0=984, and w1=40.) Different w0, w1, and b could be utilized for a block, where a block here could be a coding unit (CU), coding block (CB), prediction unit (PU), prediction block (PB), transform unit (TU), transform block (TB), coding tree unit (CTU) or a coding tree block (CTB), according to the coding information associated with the block. The coding information includes but not limited to the coding modes of the block, the size of the block, the shape of the block, the height and/or width of the block, the slice type associated with the block, the quantization parameter (QP) associated with the block and so on. The coding modes include but not limited to: intra mode, inter mode (and/or inter prediction direction), Intra block copy mode (IBC), Inter affine mode, Inter Merge mode, Inter non-merge mode, MTS applied block, LFNST applied block, SBT applied block, among others.

In some embodiments, different weight (w0/w1) could be utilized for different coefficient in a block. The coefficient in different scan position or scan index or diagonal position can have different weights. The coefficient with different coded/decoded levels or qIdx (yᵢ) can have different weight.

For example, if 940, 84 and 10 are respectively used as w0, w1 and b (as illustrated in Eq. (13)) for the TB associated with an intra mode coded block, while 982, 42 and 10 are used as the w0, w1 and b for the TB associated with a non-intra mode coded block. N1 and N2 may be any non-negative integer. The one or multiple w0, w1, and b values could be predefined at both the encoder and the decoder. Alternatively, the one or multiple w0, w1 and b values could be signaled into the bitstream at different levels such as sequence level (e.g. video parameter set and sequence parameter set), picture level (e.g. picture parameter set and picture header), slice level (e.g. slice header) and/or block level (e.g. CTU, CU, PU, TU, CTB, CB, PB, TB).

In some embodiments, different values of w0, w1, and b may be utilized depending on different yᵢ values. In one example, different w0, w1 and b values could be used for different sets of yᵢ. Specifically, one predefined set of w0, w1 and b values is used for yᵢ<=M while another predefined set of w0, w1, and b values is used for the other yᵢ values. It is noted that when w0 is assigned as equal to 1<<b, it is equivalent to disabling the quantization center shift.

In some embodiments, the reconstructed coefficient in Eq (11) is also extend to the Eq. (14) below:

$$\hat{x} = ( w 0 * {Q}^{- 1} ( {y}_{i} ) + w 1 * {Q}^{- 1} ( {y}_{i}^{′} ) + offsetBias ) ≫ b \qquad Eq . ( 14 )$$

where offsetBias is one integer, b is any non-negative integer (e.g., 10) and w0 is also a non-negative integer while w1 is also a non-negative integer and w1 may be constrained to be (1<<b)−w0. For example, offsetBias may be (1<<(b-1)), b may be 10, w0 may be 984 and w1 may be 40. In another example, offsetBias is one integer value and the sign is dependent on yᵢ.

Different offsetBias, w0, w1, and b may be utilized for a block, where a block here could be a coding unit (CU), coding block (CB), prediction unit (PU), prediction block (PB), transform unit (TU), transform block (TB), coding tree unit (CTU) or a coding tree block (CTB), according to the coding information associated with the block. The coding information includes but not limited to the coding modes of the block, the size of the block, the shape of the block, the height and/or width of the block, the slice type associated with the block, the quantization parameter (QP) associated with the block and so on. The coding modes include but not limited to: intra mode, inter mode (and/or inter prediction direction), Intra block copy mode (IBC), Inter affine mode, Inter Merge mode, Inter non-merge mode, MTS applied block, LFNST applied block, SBT applied block, among others.

In some embodiments, different weight (w0/w1) and offsetBias may be utilized for different coefficient in a block. The coefficient in different scan position or scan index or diagonal position may have different weights. The coefficient with different coded/decoded levels or yᵢ may have different weights. For example, 512, 940, 84 and 10 may be respectively used as the offsetBias, w0, w1 and b (as illustrated in Eq. (14)) for the TB associated with an intra mode coded block, while 511, 982, 42 and 10 are used as the offsetBias, w0, w1 and b for the TB associated with a non-intra mode coded block. N1 and N2 could be any non-negative integer. The one or multiple offsetBias, w0, w1, and b values could be predefined at both the encoder and the decoder. Alternatively, the one or multiple offsetBias, w0, w1, and b values may be signaled into the bitstream at different levels such as sequence level (e.g. video parameter set and sequence parameter set), picture level (e.g. picture parameter set and picture header), slice level (e.g. slice header) and/or block level (e.g. CTU, CU, PU, TU, CTB, CB, PB, TB).

Quantization involves rounding the transform coefficients provided by the transform block to integers and then dividing them by a scaling factor. This truncation and scaling of the coefficients' values result in some loss of information and introduces distortion in the reconstructed video frame. However, the quantization step ensures that the bitstream has a lower bitrate, making it possible to transmit the video data efficiently. Dequantization (or termed as scaling process), on the other hand, involves multiplying the quantized coefficients by the same scaling factor and then rounding them to the nearest integer. This operation effectively reverses the quantization process and restores some of the lost information from the compressed data.

In some embodiments, the determination of the stepsize value is additionally based on the the coding information associated with the block. The coding information includes but not limited to the coding modes of the block, the size of the block, the shape of the block, the height and/or width of the block, the slice type associated with the block, and so on. The coding modes include but not limited to: intra mode, inter mode (and/or inter prediction direction), Intra block copy mode (IBC), Inter affine mode, Inter Merge mode, Inter non-merge mode, MTS applied block, LFNST applied block, SBT applied block, among others. In some embodiments, different stepsize may be utilized for different coefficient in a block. The coefficient in different scan position or scan index or diagonal position may have different stepsize. The coefficient with different coded/decoded levels or yᵢ may have different stepsize.

In some embodiments, the stepsize is scaled up/down by the equation stepsize=(stepsize*M)/N, where M and N may be any integer values. When current block is intra mode coded, the quantization stepsize is scaled up by setting N being equal to 1024 and setting M to a larger value such as 1024+64=1088.

In some embodiments, the above mentioned “stepsize” can be replaced by levelScale or bdOffset or deQuantOffset. The coefficients in different mode/scan position/scan index/diagonal position/coded/decoded levels may have different levelScale or bdOffset or deQuantOffset.

In some embodiments, for a coefficient with a coded/decoded current coefficient level, if the difference between the number of required bins/bits of the current level and its next level (e.g., coefficient level equal to the current level+1) is smaller than a threshold (could be multiple threshold or an adaptive threshold), a variable such as N, weight, stepsize, levelScale, bdOffset, or deQuantOffset may have a different value than when the difference between the number of required bins/bits of the current level and its next level is not smaller than a threshold.

Any of the foregoing proposed methods could be applied independently or jointly. Any of the parameters used in the proposed methods could be predefined at both the encoder and the decoder. Alternatively, the parameters could also be signaled into the bitstream at different levels such as sequence level (e.g. video parameter set and sequence parameter set), picture level (e.g. picture parameter set and picture header), slice level (e.g. slice header) and/or block level (e.g. CTU, CU, PU, TU, CTB, CB, PB, TB).

Moreover, any of the foregoing proposed methods can be implemented in encoders and/or decoders. For example, any of the proposed methods can be implemented in inter prediction module of an encoder and/or a decoder. Alternatively, any of the proposed methods can be implemented as a circuit coupled to inter prediction module of the encoder and/or the decoder.

### V. Example Video Encoder

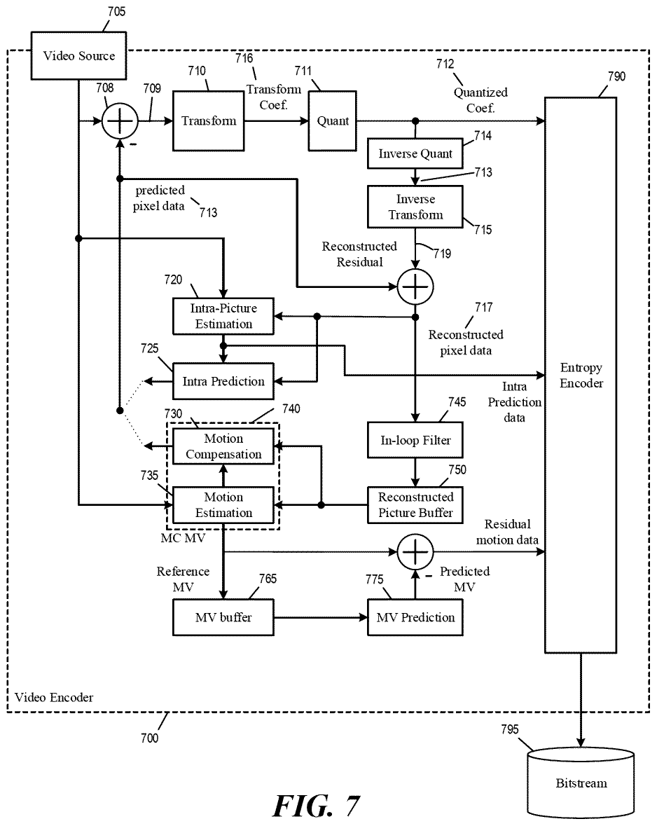

FIG. 7 illustrates an example video encoder 700 that may implement adaptive quantization. As illustrated, the video encoder 700 receives input video signal from a video source 705 and encodes the signal into bitstream 795. The video encoder 700 has several components or modules for encoding the signal from the video source 705, at least including some components selected from a transform module 710, a quantization module 711, an inverse quantization module 714, an inverse transform module 715, an intra-picture estimation module 720, an intra-prediction module 725, a motion compensation module 730, a motion estimation module 735, an in-loop filter 745, a reconstructed picture buffer 750, a MV buffer 765, and a MV prediction module 775, and an entropy encoder 790. The motion compensation module 730 and the motion estimation module 735 are part of an inter-prediction module 740.

In some embodiments, the modules 710-790 are modules of software instructions being executed by one or more processing units (e.g., a processor) of a computing device or electronic apparatus. In some embodiments, the modules 710-790 are modules of hardware circuits implemented by one or more integrated circuits (ICs) of an electronic apparatus. Though the modules 710-790 are illustrated as being separate modules, some of the modules can be combined into a single module.

The video source 705 provides a raw video signal that presents pixel data of each video frame without compression. A subtractor 708 computes the difference between the raw video pixel data of the video source 705 and the predicted pixel data 713 from the motion compensation module 730 or intra-prediction module 725 as prediction residual 709. The transform module 710 converts the difference (or the residual pixel data or residual signal 708) into transform coefficients (e.g., by performing Discrete Cosine Transform, or DCT). The quantization module 711 quantizes the transform coefficients into quantized data (or quantized coefficients) 712, which is encoded into the bitstream 795 by the entropy encoder 790.

The inverse quantization module 714 de-quantizes the quantized data (or quantized coefficients) 712 to obtain reconstructed transform coefficients 713, and the inverse transform module 715 performs inverse transform on the transform coefficients 713 to produce reconstructed residual 719. The reconstructed residual 719 is added with the predicted pixel data 713 to produce reconstructed pixel data 717. In some embodiments, the reconstructed pixel data 717 is temporarily stored in a line buffer (not illustrated) for intra-picture prediction and spatial MV prediction. The reconstructed pixels are filtered by the in-loop filter 745 and stored in the reconstructed picture buffer 750. In some embodiments, the reconstructed picture buffer 750 is a storage external to the video encoder 700. In some embodiments, the reconstructed picture buffer 750 is a storage internal to the video encoder 700.

The intra-picture estimation module 720 performs intra-prediction based on the reconstructed pixel data 717 to produce intra prediction data. The intra-prediction data is provided to the entropy encoder 790 to be encoded into bitstream 795. The intra-prediction data is also used by the intra-prediction module 725 to produce the predicted pixel data 713.

The motion estimation module 735 performs inter-prediction by producing MVs to reference pixel data of previously decoded frames stored in the reconstructed picture buffer 750. These MVs are provided to the motion compensation module 730 to produce predicted pixel data.

Instead of encoding the complete actual MVs in the bitstream, the video encoder 700 uses MV prediction to generate predicted MVs, and the difference between the MVs used for motion compensation and the predicted MVs is encoded as residual motion data and stored in the bitstream 795.

The MV prediction module 775 generates the predicted MVs based on reference MVs that were generated for encoding previously video frames, i.e., the motion compensation MVs that were used to perform motion compensation. The MV prediction module 775 retrieves reference MVs from previous video frames from the MV buffer 765. The video encoder 700 stores the MVs generated for the current video frame in the MV buffer 765 as reference MVs for generating predicted MVs.

The MV prediction module 775 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 795 by the entropy encoder 790.

The entropy encoder 790 encodes various parameters and data into the bitstream 795 by using entropy-coding techniques such as context-adaptive binary arithmetic coding (CABAC) or Huffman encoding. The entropy encoder 790 encodes various header elements, flags, along with the quantized transform coefficients 712, and the residual motion data as syntax elements into the bitstream 795. The bitstream 795 is in turn stored in a storage device or transmitted to a decoder over a communications medium such as a network.

The in-loop filter 745 performs filtering or smoothing operations on the reconstructed pixel data 717 to reduce the artifacts of coding, particularly at boundaries of pixel blocks. In some embodiments, the filtering or smoothing operations performed by the in-loop filter 745 include deblock filter (DBF), sample adaptive offset (SAO), and/or adaptive loop filter (ALF).

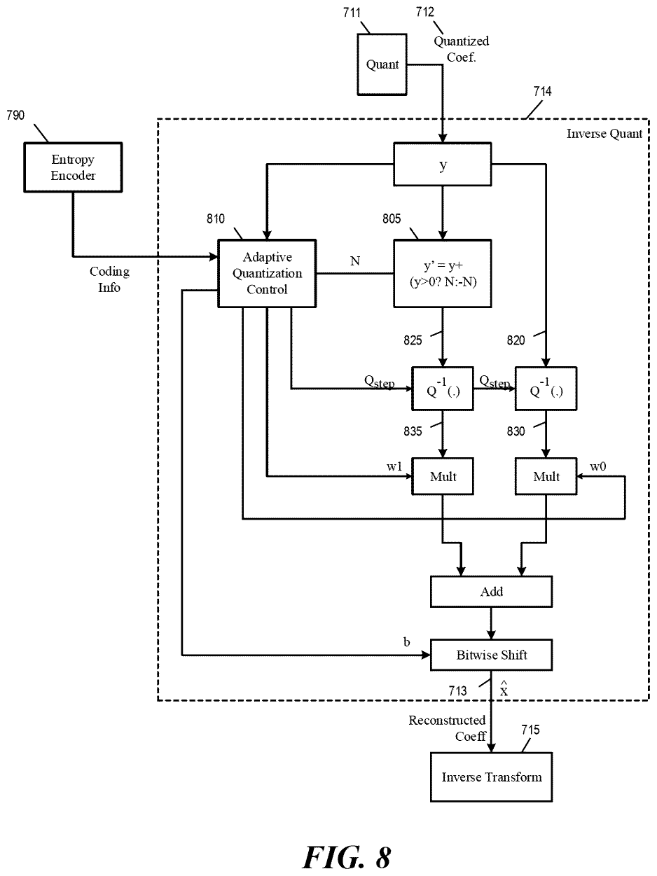

FIG. 8 illustrates portions of the video encoder 700 that implement adaptive quantization. Specifically, the figure illustrates the inverse quantization module 714 in greater detail. As illustrated, the inverse quantization module 712 receives quantization coefficients 712 from the quantization module 711 and outputs reconstructed transform coefficients 713 for the inverse transform module 715.

As illustrated, the inverse quantization module 714 performs dequantization according to Eq. (14), described above in Section IV. Specifically, each quantized coefficients 712 is used as a quantization index 810 and is used to produce a shifted quantization index 820 according to Eq. (12). A scaling operation Q⁻¹(·) (or conventional dequantization according to Eq. (4)) is applied to both the quantization index 820 and the shifted quantization index 825 to respectively produce a first dequantized value 830 and a second dequantized value 835. The inverse quantization module 714 then produces the reconstructed transform coefficient 713 based on a weighted sum of the first and second dequantized values 830 and 835. The reconstructed transform coefficient 713 is then provided to the inverse transform module 715.

The inverse quantization module 714 controls various dequantization parameters of Eq. (12) and Eq. (14), by providing Qₛₜₑₚ, N, w0, w1, and b. Among these, N is applied to a quantization index shifting module 805 performing Eq. (12) to generate the shifted quantization index 825. Qₛₜₑₚ is applied to the Q⁻¹(·) functions for scaling on the quantization index 820 and the shifted quantization index 825. When computing the weighted sum or average according to Eq. (14), w0 and w1 are weighting factors applied to the first and second dequantized values 830 and 835, and b controls how many bit positions to shift. An adaptive quantization control module 810 may set these values adaptively based on coding information (e.g., coding tools used, block size, block shape) for the current block, and/or based on the value of the incoming quantized coefficient 712, and/or is provided by the entropy encoder 790, which may also signal these parameters in the bitstream 795 in any of the various video coding hierarchies (slice header, picture header, etc.)

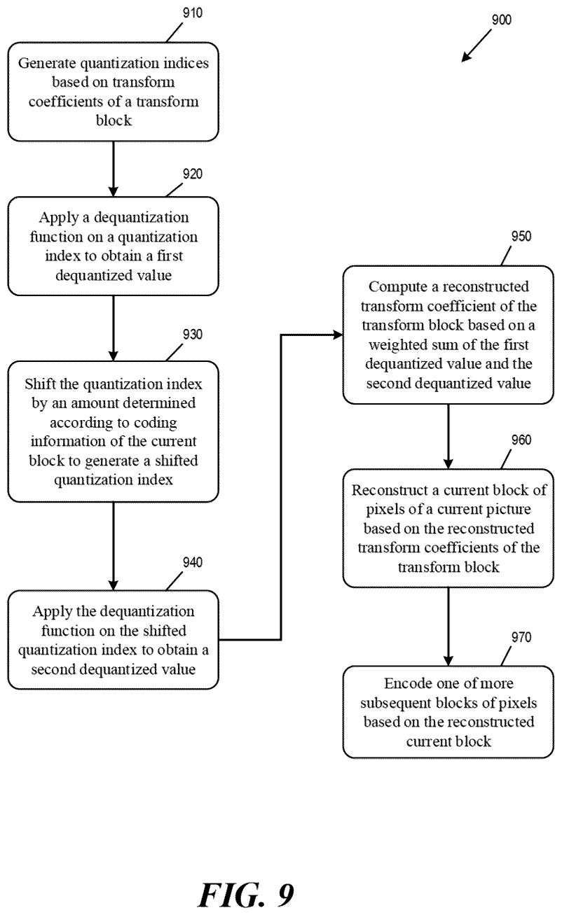

FIG. 9 conceptually illustrates a process 900 that uses adaptive quantization in encoding pixel blocks. In some embodiments, one or more processing units (e.g., a processor) of a computing device implementing the encoder 700 performs the process 900 by executing instructions stored in a computer readable medium. In some embodiments, an electronic apparatus implementing the encoder 700 performs the process 900.

The encoder generates (at block 910) quantization indices based on transform coefficients of a transform block. The encoder applies (at block 920) a dequantization function on a quantization index to obtain a first dequantized value.

The encoder shifts (at block 930) the quantization index by an amount determined according to coding information of the current block to generate a shifted quantization index, in some embodiments, away from zero by applying an offset having a same sign as the quantization index as shown in Eq. (12). Specifically, in some embodiments, the encoder shifts the quantization index away from zero by adding or subtracting N to the quantization index, N being a positive integer. In some embodiments, N is 1. In some embodiments, N greater than 1. In some embodiments, N is determined based on coding information of the current block, such that, for example, N is a first value when a first coding tool is used to encode the current block and a second, different value when a second coding tool is used to encode the current block. The coding information may be anyone of the size/shape of the block, the coding tool used code the block, etc.

In some embodiments, N is a value indicated at a particular hierarchical level of a coded video bitstream, such as sequence level, (e.g. video parameter set and sequence parameter set), picture level (e.g. picture parameter set and picture header), slice level (e.g. slice header) and/or block level (e.g. CTU, CU, PU, TU, CTB, CB, PB, TB). In some embodiments, N is predefined at corresponding video codecs. In some embodiments, N is determined based on the value of the quantization index, for example, N may take different values based on whether the quantization index is greater or less than a threshold.

The encoder applies (at block 940) the dequantization function on the shifted quantization index to obtain a second dequantized value. The encoder may apply the dequantization function by scaling the quantization index by a quantization stepsize (Qₛₜₑₚ). In some embodiments, the quantization stepsize may be determined based on the coding information of the current block.

The encoder computes (at block 950) a reconstructed transform coefficient of the transform block based on a weighted sum of the first dequantized value and the second dequantized value. Specifically, the encoder may compute the weighted sum by weighting the first dequantized value by a first weighting value (w0) and weighting the second dequantized value by a second weighting value (w1). The encoder may also compute the reconstructed transform coefficient by bitwise shifting the weighted sum by B bits.

In some embodiments, the encoder may determine B, w0, and w1 based on the coding information of the current block (e.g., the B or w0 or w1 may be set to a first value when a first coding tool is used to encode the current block and a second, different value when a second coding tool is used to encode the current block.) In some embodiments, the values of B, w0 and w1 are indicated by syntax elements at a particular hierarchical level of a coded video bitstream, such as sequence level, (e.g. video parameter set and sequence parameter set), picture level (e.g. picture parameter set and picture header), slice level (e.g. slice header) and/or block level (e.g. CTU, CU, PU, TU, CTB, CB, PB, TB). In some embodiments, B, w0, and w1 are predefined at corresponding video codecs. In some embodiments, B, w0, and w1 are determined based on the value of the quantization index.

The encoder reconstructs (at block 960) a current block of pixels of a current picture based on the reconstructed transform coefficients of the transform block. The encoder (at block 970) encodes one of more subsequent blocks of pixels based on the reconstructed current block, by e.g., using the reconstructed current block to generate a prediction block to produce prediction residuals.

### VI. Example Video Decoder

In some embodiments, an encoder may signal (or generate) one or more syntax element in a bitstream, such that a decoder may parse said one or more syntax element from the bitstream.

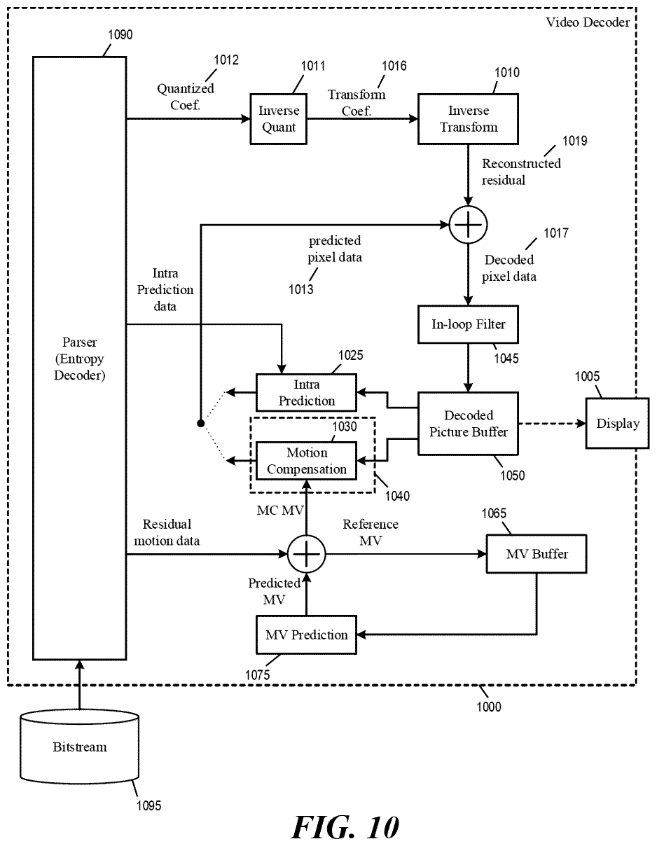

FIG. 10 illustrates an example video decoder 1000 that may perform adaptive quantization. As illustrated, the video decoder 1000 is an image-decoding or video-decoding circuit that receives a bitstream 1095 and decodes the content of the bitstream into pixel data of video frames for display. The video decoder 1000 has several components or modules for decoding the bitstream 1095, including some components selected from an inverse quantization module 1011, an inverse transform module 1010, an intra-prediction module 1025, a motion compensation module 1030, an in-loop filter 1045, a decoded picture buffer 1050, a MV buffer 1065, a MV prediction module 1075, and a parser 1090. The motion compensation module 1030 is part of an inter-prediction module 1040.

In some embodiments, the modules 1010-1090 are modules of software instructions being executed by one or more processing units (e.g., a processor) of a computing device. In some embodiments, the modules 1010-1090 are modules of hardware circuits implemented by one or more ICs of an electronic apparatus. Though the modules 1010-1090 are illustrated as being separate modules, some of the modules can be combined into a single module.

The parser 1090 (or entropy decoder) receives the bitstream 1095 and performs initial parsing according to the syntax defined by a video-coding or image-coding standard. The parsed syntax element includes various header elements, flags, as well as quantized data (or quantized coefficients) 1012. The parser 1090 parses out the various syntax elements by using entropy-coding techniques such as context-adaptive binary arithmetic coding (CABAC) or Huffman encoding.

The inverse quantization module 1011 de-quantizes the quantized data (or quantized coefficients) 1012 to obtain transform coefficients, and the inverse transform module 1010 performs inverse transform on the transform coefficients 1016 to produce reconstructed residual signal 1019. The reconstructed residual signal 1019 is added with predicted pixel data 1013 from the intra-prediction module 1025 or the motion compensation module 1030 to produce decoded pixel data 1017. The decoded pixels data are filtered by the in-loop filter 1045 and stored in the decoded picture buffer 1050. In some embodiments, the decoded picture buffer 1050 is a storage external to the video decoder 1000. In some embodiments, the decoded picture buffer 1050 is a storage internal to the video decoder 1000.

The intra-prediction module 1025 receives intra-prediction data from bitstream 1095 and according to which, produces the predicted pixel data 1013 from the decoded pixel data 1017 stored in the decoded picture buffer 1050. In some embodiments, the decoded pixel data 1017 is also stored in a line buffer (not illustrated) for intra-picture prediction and spatial MV prediction.

In some embodiments, the content of the decoded picture buffer 1050 is used for display. A display device 1005 either retrieves the content of the decoded picture buffer 1050 for display directly, or retrieves the content of the decoded picture buffer to a display buffer. In some embodiments, the display device receives pixel values from the decoded picture buffer 1050 through a pixel transport.

The motion compensation module 1030 produces predicted pixel data 1013 from the decoded pixel data 1017 stored in the decoded picture buffer 1050 according to motion compensation MVs (MC MVs). These motion compensation MVs are decoded by adding the residual motion data received from the bitstream 1095 with predicted MVs received from the MV prediction module 1075.

The MV prediction module 1075 generates the predicted MVs based on reference MVs that were generated for decoding previous video frames, e.g., the motion compensation MVs that were used to perform motion compensation. The MV prediction module 1075 retrieves the reference MVs of previous video frames from the MV buffer 1065. The video decoder 1000 stores the motion compensation MVs generated for decoding the current video frame in the MV buffer 1065 as reference MVs for producing predicted MVs.

The in-loop filter 1045 performs filtering or smoothing operations on the decoded pixel data 1017 to reduce the artifacts of coding, particularly at boundaries of pixel blocks. In some embodiments, the filtering or smoothing operations performed by the in-loop filter 1045 include deblock filter (DBF), sample adaptive offset (SAO), and/or adaptive loop filter (ALF).

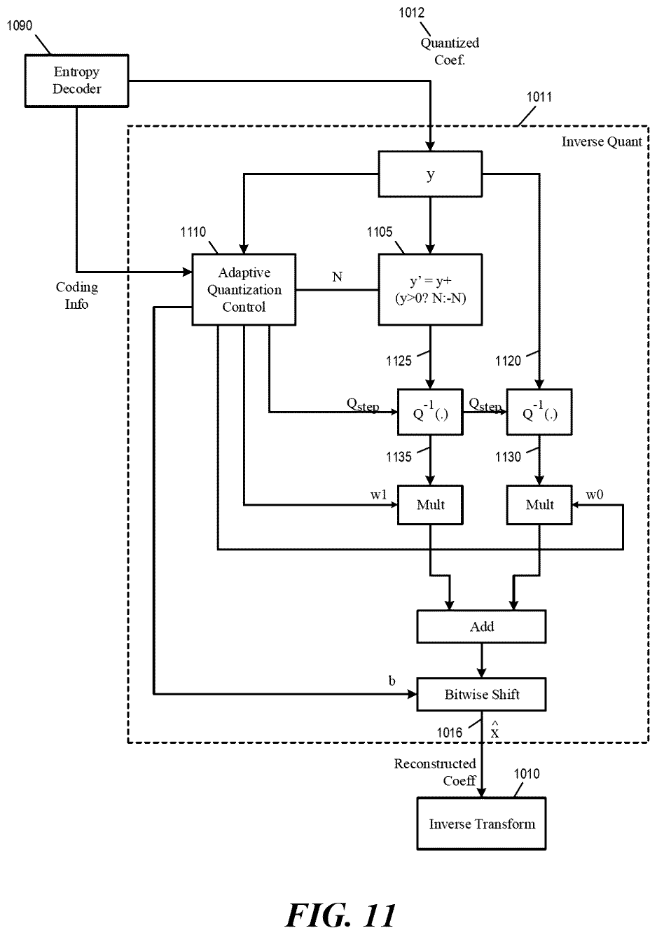

FIG. 11 illustrates portions of the video decoder 1000 that implement adaptive quantization. Specifically, the figure illustrates the inverse quantization module 1011 in greater detail. As illustrated, the inverse quantization module 1012 receives quantization coefficients 1012 from the entropy decoder and outputs reconstructed transform coefficients 1016 for the inverse transform module 1010.

As illustrated, the inverse quantization module 1011 performs dequantization according to Eq. (14), described above in Section IV. Specifically, each quantized coefficients 1012 is used as a quantization index 1110 and is used to produce a shifted quantization index 1120 according to Eq. (12). A scaling operation Q⁻¹(·) (or conventional dequantization according to Eq. (4)) is applied to both the quantization index 1120 and the shifted quantization index 1125 to respectively produce a first dequantized value 1130 and a second dequantized value 1135. The inverse quantization module 1011 then produces the reconstructed transform coefficient 1016 based on a weighted sum of the first and second dequantized values 1130 and 1135. The reconstructed transform coefficient 1016 is then provided to the inverse transform module 1010.

The inverse quantization module 1011 controls various dequantization parameters of Eq. (12) and Eq. (14), by providing Qₛₜₑₚ, N, w0, w1, and b. Among these, N is applied to a quantization index shifting module 1105 performing Eq. (12) to generate the shifted quantization index 1125. Qₛₜₑₚ is applied to the Q⁻¹(·) functions for scaling on the quantization index 1120 and the shifted quantization index 1125. When computing the weighted sum or average according to Eq. (14), w0 and w1 are weighting factors applied to the first and second dequantized values 1130 and 1135, and b controls how many bit positions to shift. An adaptive quantization control module 1110 may set these values adaptively based on coding information (e.g., coding tools used, block size, block shape) for the current block, and/or based on the value of the incoming quantized coefficient 1012, and/or is provided by the entropy decoder 1090, which may also receive these parameters from the bitstream 1095 in any of the various video coding hierarchies.

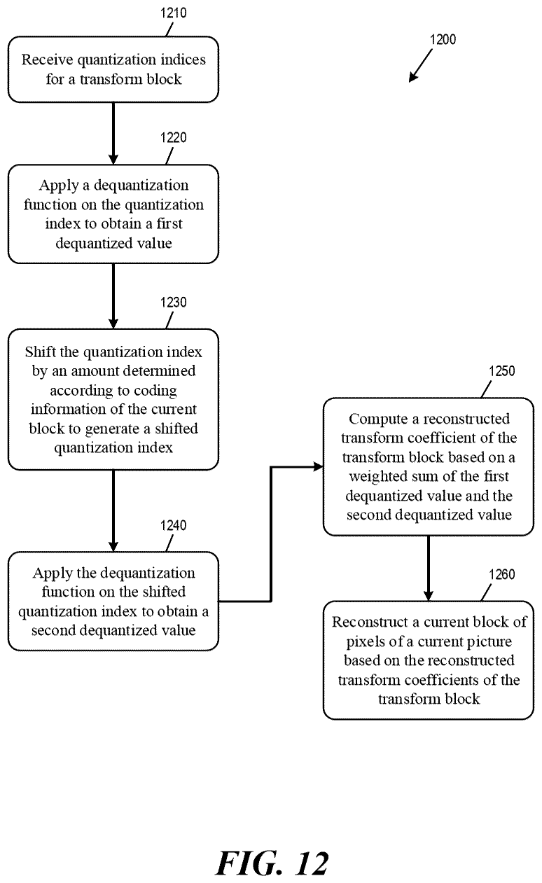

FIG. 12 conceptually illustrates a process 1200 that uses adaptive quantization in decoding pixel blocks. In some embodiments, one or more processing units (e.g., a processor) of a computing device implementing the decoder 700 performs the process 1200 by executing instructions stored in a computer readable medium. In some embodiments, an electronic apparatus implementing the decoder 700 performs the process 1200.

The decoder receives (at block 1210) quantization indices based on transform coefficients of a transform block. The quantization indices may be quantized coefficient levels.

The decoder applies (at block 1220) a dequantization function on a quantization index to obtain a first dequantized value. The decoder shifts (at block 1230) the quantization index according to coding information of the current block to generate a shifted quantization index, in some embodiments, away from zero by applying an offset having a same sign as the quantization index as shown in Eq. (12). Specifically, in some embodiments, the decoder shifts the quantization index away from zero by adding or subtracting N to the quantization index, N being a positive integer. In some embodiments, N is 1. In some embodiments, N greater than 1. In some embodiments, N is determined based on coding information of the current block, such that, for example, N is a first value when a first coding tool is used to decode the current block and a second, different value when a second coding tool is used to decode the current block. The coding information may be anyone of the size/shape of the block, the coding tool (e.g., prediction mode) used code the block, etc.

In some embodiments, N is a value indicated at a particular hierarchical level of a coded video bitstream, such as sequence level, (e.g. video parameter set and sequence parameter set), picture level (e.g. picture parameter set and picture header), slice level (e.g. slice header) and/or block level (e.g. CTU, CU, PU, TU, CTB, CB, PB, TB). In some embodiments, N is predefined at corresponding video codecs. In some embodiments, N is determined based on the value of the quantization index, for example, N may take different values based on whether the quantization index is greater or less than a threshold.

The decoder applies (at block 1240) the dequantization function on the shifted quantization index to obtain a second dequantized value. The decoder may apply the dequantization function by scaling the quantization index by a quantization stepsize (Qₛₜₑₚ). In some embodiments, the quantization stepsize may be determined based on the coding information of the current block.

The decoder computes (at block 1250) a reconstructed transform coefficient of the transform block based on a weighted sum of the first dequantized value and the second dequantized value. Specifically, the decoder may compute the weighted sum by weighting the first dequantized value by a first weighting value (w0) and weighting the second dequantized value by a second weighting value (w1). The decoder may also compute the reconstructed transform coefficient by bitwise shifting the weighted sum by B bits.

In some embodiments, the decoder may determine B, w0, and w1 based on the coding information of the current block (e.g., the B or w0 or w1 may be set to a first value when a first coding tool is used to decode the current block and a second, different value when a second coding tool is used to decode the current block.) In some embodiments, the values of B, w0 and w1 are indicated by syntax elements at a particular hierarchical level of a coded video bitstream, such as sequence level, (e.g. video parameter set and sequence parameter set), picture level (e.g. picture parameter set and picture header), slice level (e.g. slice header) and/or block level (e.g. CTU, CU, PU, TU, CTB, CB, PB, TB). In some embodiments, B, w0, and w1 are predefined at corresponding video codecs. In some embodiments, B, w0, and w1 are determined based on the value of the quantization index.

The decoder reconstructs (at block 1260) a current block of pixels of a current picture based on the reconstructed transform coefficients of the transform block and by using a selected coding tool to generate a prediction block. The decoder may then provide the reconstructed current block for display as part of the reconstructed current picture.

### VII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

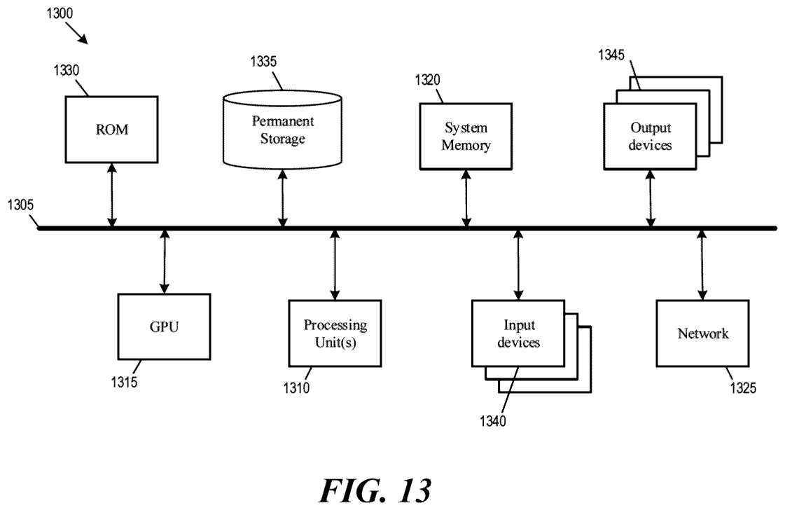

FIG. 13 conceptually illustrates an electronic system 1300 with which some embodiments of the present disclosure are implemented. The electronic system 1300 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1300 includes a bus 1305, processing unit(s) 1310, a graphics-processing unit (GPU) 1315, a system memory 1320, a network 1325, a read-only memory 1330, a permanent storage device 1335, input devices 1340, and output devices 1345.

The bus 1305 collectively represents all system, peripheral, and chipset buses that communicatively connect the numerous internal devices of the electronic system 1300. For instance, the bus 1305 communicatively connects the processing unit(s) 1310 with the GPU 1315, the read-only memory 1330, the system memory 1320, and the permanent storage device 1335.

From these various memory units, the processing unit(s) 1310 retrieves instructions to execute and data to process in order to execute the processes of the present disclosure. The processing unit(s) may be a single processor or a multi-core processor in different embodiments. Some instructions are passed to and executed by the GPU 1315. The GPU 1315 can offload various computations or complement the image processing provided by the processing unit(s) 1310.

The read-only-memory (ROM) 1330 stores static data and instructions that are used by the processing unit(s) 1310 and other modules of the electronic system. The permanent storage device 1335, on the other hand, is a read-and-write memory device. This device is a non-volatile memory unit that stores instructions and data even when the electronic system 1300 is off. Some embodiments of the present disclosure use a mass-storage device (such as a magnetic or optical disk and its corresponding disk drive) as the permanent storage device 1335.

Other embodiments use a removable storage device (such as a floppy disk, flash memory device, etc., and its corresponding disk drive) as the permanent storage device. Like the permanent storage device 1335, the system memory 1320 is a read-and-write memory device. However, unlike storage device 1335, the system memory 1320 is a volatile read-and-write memory, such a random access memory. The system memory 1320 stores some of the instructions and data that the processor uses at runtime. In some embodiments, processes in accordance with the present disclosure are stored in the system memory 1320, the permanent storage device 1335, and/or the read-only memory 1330. For example, the various memory units include instructions for processing multimedia clips in accordance with some embodiments. From these various memory units, the processing unit(s) 1310 retrieves instructions to execute and data to process in order to execute the processes of some embodiments.

The bus 1305 also connects to the input and output devices 1340 and 1345. The input devices 1340 enable the user to communicate information and select commands to the electronic system. The input devices 1340 include alphanumeric keyboards and pointing devices (also called “cursor control devices”), cameras (e.g., webcams), microphones or similar devices for receiving voice commands, etc. The output devices 1345 display images generated by the electronic system or otherwise output data. The output devices 1345 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 13, bus 1305 also couples electronic system 1300 to a network 1325 through a network adapter (not shown). In this manner, the computer can be a part of a network of computers (such as a local area network (“LAN”), a wide area network (“WAN”), or an Intranet, or a network of networks, such as the Internet. Any or all components of electronic system 1300 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 9 and FIG. 12) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving quantization indices for a transform block;
applying a dequantization function on the quantization index to obtain a first dequantized value;
shifting the quantization index by an amount determined based on a coding information of the current block to generate a shifted quantization index;
applying the dequantization function on the shifted quantization index to obtain a second dequantized value;
computing a reconstructed transform coefficient of the transform block based on a weighted sum of the first dequantized value and the second dequantized value; and
reconstructing a current block of pixels of a current picture based on the reconstructed transform coefficients of the transform block.

2. The video coding method of claim 1, wherein shifting the quantization index comprises adding N to or subtracting N from the quantization index, N being a positive integer.

3. The video coding method of claim 2, wherein N is a positive integer greater than one.

4. The video coding method of claim 2, wherein N is signaled into a video bitstream.

5. The video coding method of claim 4, wherein N is a value indicated at a particular hierarchical level of the video bitstream.

6. The video coding method of claim 2, wherein N is predefined at a video decoder and a video encoder.

7. The video coding method of claim 2, wherein N is determined based on the value of the quantization index.

8. The video coding method of claim 1, wherein computing the weighted sum comprises weighting the first dequantized value by a first weighting value and weighting the second dequantized value by a second weighting value.

9. The video coding method of claim 1, wherein computing the reconstructed transform coefficient comprises bitwise shifting the weighted sum by B bits.

10. The video coding method of claim 9, wherein B and the first and second weighting values are determined based on coding information of the current block.

11. The video coding method of claim 9, wherein B and the first and second weighting values are indicated at a particular hierarchical level of a coded video bitstream.

12. The video coding method of claim 9, wherein B and the first and second weighting values are predefined at a video decoder and a video encoder.

13. The video coding method of claim 9, wherein B and the first and second weighting values are determined based on the value of the quantization index.

14. The video coding method of claim 9, wherein B and the first and second weighting values are signaled into the video bitstream.

15. The video coding method of claim 1, wherein applying the dequantization function comprises scaling the quantization index by a quantization stepsize that is determined based on a coding information of the current block.

16. An electronic apparatus comprising:
a video coder circuit configured to perform operations comprising:
receiving quantization indices for a transform block;
applying a dequantization function on the quantization index to obtain a first dequantized value;
shifting the quantization index by an amount determined based on a coding information of the current block to generate a shifted quantization index;
applying the dequantization function on the shifted quantization index to obtain a second dequantized value;
computing a reconstructed transform coefficient of the transform block based on a weighted sum of the first dequantized value and the second dequantized value; and
reconstructing a current block of pixels of a current picture based on the reconstructed transform coefficients of the transform block.

17. A video encoding method comprising:
generating quantization indices based on transform coefficients of a transform block;
applying a dequantization function on a quantization index to obtain a first dequantized value;
shifting the quantization index by an amount determined based on a coding information of the current block to generate a shifted quantization index;
applying the dequantization function on the shifted quantization index to obtain a second dequantized value;
computing a reconstructed transform coefficient of the transform block based on a weighted sum of the first dequantized value and the second dequantized value;
reconstructing a current block of pixels of a current picture based on the reconstructed transform coefficients of the transform block; and
encoding one of more subsequent blocks of pixels based on the reconstructed current block.
